(19) United States
(12) Patent Application Publication
(10) Pub. No.: US 2026/0118492 A1
(43) Pub. Date: Apr. 30, 2026

(54) SYSTEMS AND METHODS FOR MONITORING HEALTH OF A LIDAR SENSOR IN UNCONTROLLED ENVIRONMENTS

(71) Applicant: GM GLOBAL TECHNOLOGY OPERATIONS LLC, Detronit, MI (US)

(72) Inventors: Ehsan JAFARZADEH, Toronto (CA); Hossein Sadjadi, Thornhill (CA); Jacqueline Del Gatto, Oshawa (CA); Graham Cran, Hamilton (CA); Tung-Wah Frederick Chang, Richmond Hill (CA)

(21) Appl. No.: 18/925,312

(22) Filed: Oct. 24, 2024

(51) Int. Cl. G01S 7/497; G01S 17/931

(52) U.S. Cl. CPC G01S 7/497; G01S 17/931

(57) ABSTRACT

A health monitoring system for a light detection and ranging (LiDAR) sensor of a vehicle includes a LiDAR sensor configured to generate light pulses and to receive returns. A location identifying module is configured to identify locations that are visited by the vehicle, identify selected ones of the locations as frequently visited locations, generate metrics for the frequently visited locations based on the returns from the LiDAR sensor, and based on the metrics, pick selected ones of the frequently visited locations as selected locations for monitoring health of the LiDAR sensor. A health monitoring module is configured to generate health metrics for the LiDAR sensor when the vehicle is located at the selected locations.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to driver assistance systems, and more particularly to driver assistance systems including light detection and ranging (LiDAR) sensors.

Vehicles include various levels of driver assistance (such as fully or partially autonomous vehicles). Autonomous vehicles often rely on light detection and ranging (LiDAR) systems to detect and avoid objects in a path of the vehicle. The health of the LiDAR sensor is typically evaluated by the manufacturer using a dedicated test setup that provides a controlled environment and targets with known reflectivity. After the vehicle is sold, however, this type of testing environment is not readily accessible to assess the health of the LiDAR sensor.

### SUMMARY

A health monitoring system for a light detection and ranging (LiDAR) sensor of a vehicle includes a LiDAR sensor configured to generate light pulses and to receive returns. A location identifying module is configured to identify locations that are visited by the vehicle; identify selected ones of the locations as frequently visited locations; generate metrics for the frequently visited locations based on the returns from the LiDAR sensor; and based on the metrics, pick selected ones of the frequently visited locations as selected locations for monitoring health of the LiDAR sensor. A health monitoring module is configured to generate health metrics for the LiDAR sensor when the vehicle is located at the selected locations.

In other features, one or more of the metrics are selected from a group consisting of signal to noise ratio, number of return points, and variation in reflectivity. The location identifying module is configured to pick the selected ones of the frequently visited locations as selected locations by assigning useability scores to the frequently visited locations based on the metrics; ranking the frequently visited locations based on the useability scores; and picking the selected locations based on the ranking.

In other features, the health monitoring module is configured to select one visit to each of the selected locations as corresponding reference data. The health monitoring module is configured to apply enabling criteria for each of the visits to the selected locations. The enabling criteria is selected from a group consisting of vehicle location, temperature, light level, time of day, reference object location, and combinations thereof.

In other features, the health monitoring module is configured to combine metrics from complementary ones of the selected locations. The health monitoring module is configured to apply a function to the health metrics for each of the selected locations to generate matured health metrics. The health monitoring module is configured to fuse one or more of the matured health metrics for two or more of the selected locations to generate a fused metric. The health monitoring module is configured to compare the fused metric to a predetermined threshold to evaluate the health of the LiDAR sensor.

A method for evaluating health of a light detection and ranging (LiDAR) sensor includes generating light pulses and receiving returns using a LiDAR sensor of a vehicle; identifying locations that are visited by the vehicle; identifying selected ones of the locations as frequently visited locations; generating metrics for the frequently visited locations based on the returns from the LiDAR sensor; based on the metrics, picking selected ones of the frequently visited locations as selected locations for monitoring health of the LiDAR sensor; and generating health metrics for the LiDAR sensor when the vehicle is located at the selected locations.

In other features, the method include selecting the metrics from a group consisting of signal to noise ratio, number of return points, and variation in reflectivity. Picking the selected ones of the frequently visited locations as selected locations includes assigning useability scores to the frequently visited locations based on the metrics; ranking the frequently visited locations based on the useability scores; and picking the selected locations based on the ranking.

In other features, the method includes selecting one visit to each of the selected locations as reference data. The method includes applying enabling criteria for each of the visits to the selected locations. The method includes selecting the enabling criteria from a group consisting of vehicle location, temperature, light level, time of day, reference object location, and combinations thereof. The method includes combining metrics from complementary ones of the selected locations. The method includes applying a function to the health metrics for each of the selected locations to generate matured health metrics.

In other features, the method includes fusing metrics for two or more of the selected locations to generate a fused metric; and comparing the fused metric to a predetermined threshold to evaluate the health of the LiDAR sensor.

A vehicle comprises a light detection and ranging (LiDAR) sensor configured to generate light pulses and to receive returns and a global positioning system (GPS). A health assessment module in communication with the LiDAR sensor and the GPS includes a location identifying module configured to identify locations that are visited by the vehicle, identify selected ones of the locations as frequently visited locations, generate metrics for the frequently visited locations based on the returns from the LiDAR sensor, and based on the metrics, pick selected ones of the frequently visited locations as selected locations for monitoring health of the LiDAR sensor. The health assessment module includes a health monitoring module configured to generate health metrics for the LiDAR sensor when the vehicle is located at the selected locations.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle including a health assessment module configured to evaluate the health of a light detection and ranging (LiDAR) sensor according to the present disclosure;

FIG. 2 is a flowchart of an example of a method for selecting frequently visited locations for health assessment of the LiDAR sensor and assessing the health of the LiDAR sensor at the selected locations according to the present disclosure;

FIGS. 3A to 3C illustrate examples of first, second and third frequently visited locations of the vehicle according to the present disclosure;

FIGS. 4A to 4C illustrate examples of variations encountered during different visits to the same frequently visited location according to the present disclosure;

FIGS. 5A to 5C illustrate an example of selection or rejection of the first, second and third frequently visited locations as selected locations for assessment of the health of the LiDAR sensor according to the present disclosure;

FIG. 6 is a flowchart of an example of a method for identifying frequently visited locations according to the present disclosure;

FIG. 7A is a flowchart of an example of a method for selecting locations suitable for LiDAR health assessment according to the present disclosure;

FIG. 7B is a flowchart of an example of a method for assigning useability scores according to the present disclosure;

FIG. 7C is a flowchart of an example of a method for ranking frequently visited locations suitable for health assessment of the LiDAR sensor according to the present disclosure;

FIG. 7D is a flowchart of an example of a method for storing properties, health indicators, and orientation for each of the selected locations according to the present disclosure;

FIG. 8 is a flowchart of an example of a method for eliminating variations across multiple visits according to the present disclosure; and

FIG. 9 is a flowchart of an example of a method for monitoring health and health degradation of the LiDAR sensor according to the present disclosure.

In the drawings, reference numbers may be reused to identify similar and/or identical elements.

### DETAILED DESCRIPTION

Systems and methods according to the present disclosure monitor the health and health degradation of one or more light detection and ranging (LiDAR) sensors. In some examples, the LiDAR sensor(s) form part of an autonomous driving system of a vehicle.

The health monitoring systems and methods identify locations that are frequently visited by the vehicle and select one or more of the frequently visited locations for evaluating the health of the LiDAR sensor to identify health degradation. The health monitoring systems and methods identify, rank, and group frequently visited locations of the vehicle. Some of these locations are selected and used on a regular basis for evaluation of the health of the LiDAR sensor. The reference locations are remote from controlled environments that are typically used by a manufacturer or service facility to evaluate the LiDAR sensor.

When the vehicle is at the same location and has the same orientation, the return data from the LiDAR sensor should be roughly the same (e.g., after adjusting for changes due to environmental factors, etc.). One of the visits to each of the selected locations is designated as reference data. Data from other visits to the selected locations is compared to the reference data. Differences in the return data during the other visits are used to evaluate the health degradation of the LiDAR sensor.

Referring now to FIG. 1, a vehicle 100 includes a driver assistance controller 110 including a health assessment module 112. A global positioning system (GPS)/compass 120 determines a position, path, and/or orientation of the vehicle 100 and outputs the GPS/compass data to the driver assistance controller 110. A radar system 122 optionally generates radio frequency pulses and outputs radar return signals to the driver assistance controller 110. In some examples, the driver assistance controller 110 includes an autonomous driving module 160 configured to operate the vehicle 100 fully and/or partially in an autonomous driving mode by controlling vehicle controls 164 (such as a steering wheel, a brake pedal, an acceleration pedal, etc.) based on outputs of a LiDAR sensor 124 and/or other sensors.

The LiDAR sensor 124 generates light pulses in a path of the vehicle and receives return signals. In some examples, the LiDAR sensor includes one or more lasers 130 and one or more scanners 128 that scan the one or more lasers 130 in vehicle path or field of view of the vehicle operator. The health assessment module 112 includes a location identifying module 142 configured to identify frequently visited locations, select one or more of the locations as selected locations for health assessment, and perform other functions described herein. A health degradation module 144 is configured to cause testing to be performed at the selected locations and to assess the health and/or health degradation of the LiDAR sensor 124.

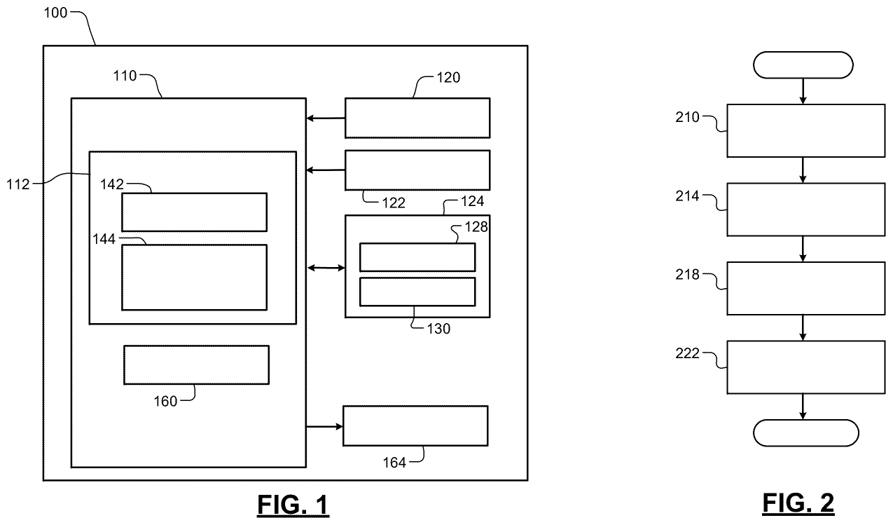

Referring now to FIG. 2, a method for monitoring the health of the LiDAR sensor 124 is shown. At 210, locations that are frequently visited by the vehicle are identified. At 214, one or more frequently visited locations are selected for LiDAR health assessment. At 218, compensation for variations (such as different vehicle orientation, position, environmental factors, etc.) is performed across multiple visits to the frequently visited locations. At 222, LiDAR health is assessed and degradation of the health of the LiDAR sensor is monitored over time.

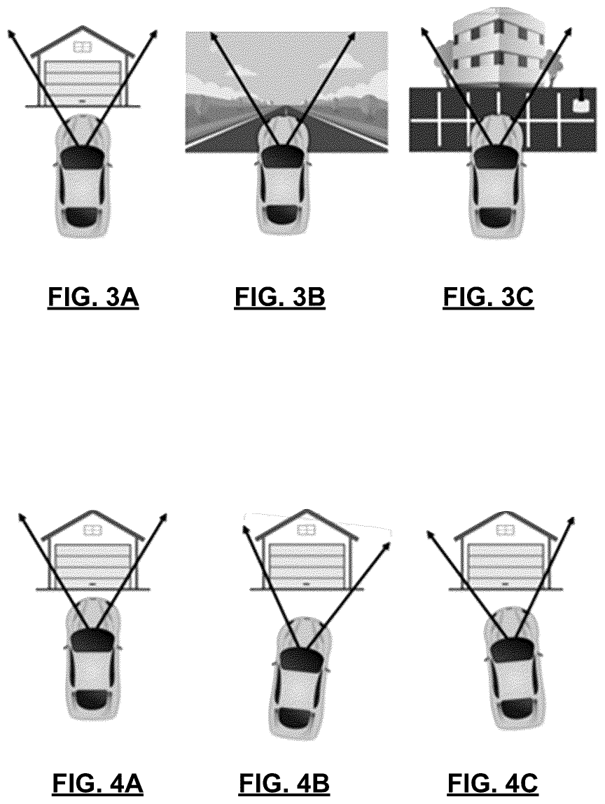

Referring now to FIGS. 3A to 5C, examples of identifying and selecting frequently visited locations are shown. In FIG. 3A, a vehicle location such as a driveway of the operator is evaluated as a possible location for health assessment of the LiDAR sensor. In FIG. 3B, a vehicle location such as a country road is evaluated as a possible location of the LiDAR sensor. In FIG. 3C, a vehicle location such as an office building or work location of the operator is evaluated as a possible location of the LiDAR sensor.

In FIGS. 4A to 4C, data generated by the LiDAR sensor 124 may vary when visiting the same location due to different conditions (e.g., orientation and position of the vehicle relative to objects that are detected, environmental factors, etc.) at the selected location. In FIG. 4A, a vehicle location such as a driveway of the operator is a selected location and return data is collected. In this visit, the orientation of the vehicle is approximately square relative to the garage. In the visit in FIG. 4B, the orientation of the vehicle is at a first offset angle relative to the garage. In the visit in FIG. 4C, the orientation of the vehicle is at a second offset angle relative to the garage. In some examples, the health assessment module 112 performs a transform on the return from the LiDAR sensor 124 to reduce variations due to the orientation of the vehicle. Similar compensation can be provided for environmental factors.

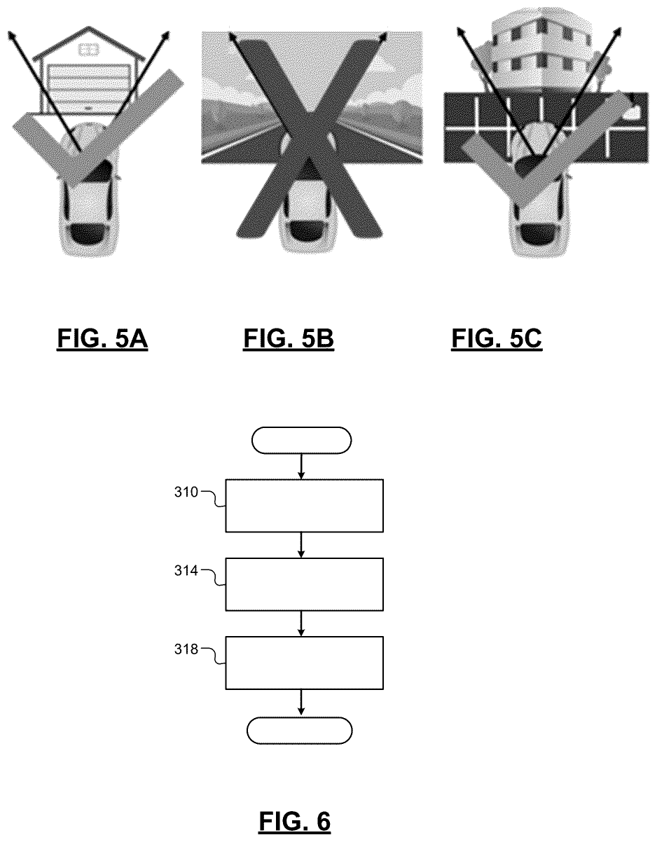

In FIGS. 5A to 5C, one or more locations are selected for LiDAR health assessment. In FIG. 5A, a vehicle location such as a driveway of the operator is selected since it is frequently visited and provides good return data for analyzing the health of the LiDAR sensor 124. In FIG. 5B, a vehicle location such as a country road is not selected since it does not provide good return data for analyzing the health of the LiDAR sensor 124. In FIG. 5C, a vehicle location such as an office building or work location of the operator is selected since it is frequently visited and provides good return data for analyzing the health of the LiDAR sensor 124.

Referring now to FIG. 6, a method for identifying frequently visited locations in step 210 of FIG. 2 is shown. At 310, the GPS data is used to record locations visited by the vehicle. At 314, the locations are monitored over time to identify frequently visited locations. For example, frequently visited locations often include home, work, charging stations, grocery stores, daycare locations, etc. At 318, return data from the LiDAR sensor 124 is stored for the frequently visited locations.

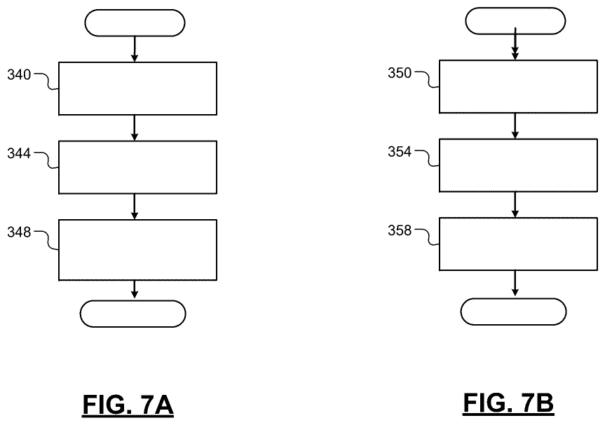

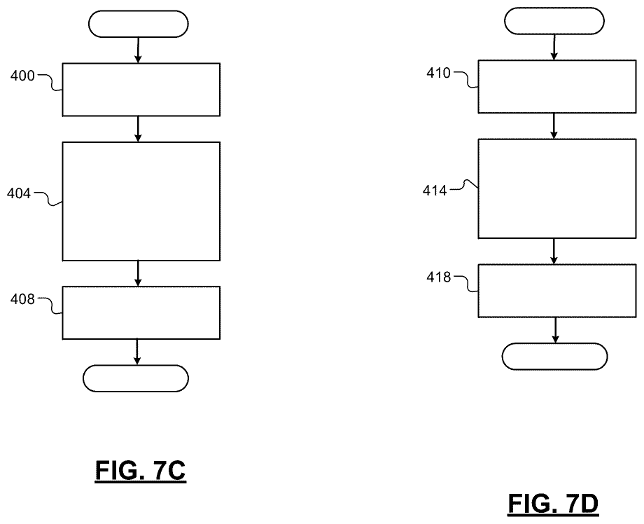

Referring now to FIGS. 7A to 7D, a method for selecting locations suitable for LiDAR health assessment in step 214 of FIG. 2 is shown. At 340 in FIG. 7A, useability scores are assigned to each location based on the return data collected over time. At 344, locations are ranked and grouped into complementary locations. At 348, properties, health indicators, and/or optimum poses for each selected location are stored.

In FIG. 7B, steps for assigning useability scores in step 340 of FIG. 7A are shown. At 350, point cloud data from the LiDAR sensor 124 at each of the frequently visited locations is used to calculate health metrics. Examples of health metrics include signal to noise ratio (SNR), number of return points, variation in reflectivity, and/or other metrics. At 354, the frequently visited locations are evaluated for LiDAR health assessment using the metrics that are generated. At 358, the useability scores are determined based on calculated metrics at each location.

In FIG. 7C, steps for ranking and grouping in step 344 of FIG. 7A are shown. At 400, the frequently visited locations are ranked based on the useability score. Some of the frequently visited locations can be selected for measurement of a subset of the metrics (based on the quality of the return data) but not used for at least one of the metrics. Other ones of the frequently visited locations can be selected for measuring all of the metrics and/or a different subset of the metrics.

At 404, a forward selection method is used to determine whether two or more of the locations complement each other and can be fused or combined. In other words, the health assessment module may combine data from two or more of the frequently visited locations for a particular metric. In some examples, the criterion for forward selection includes an overall useability score for the combined locations using all or a subset of the metrics. At 408, a list of selected locations to perform the health monitoring is created.

In FIG. 7D, steps for storing properties, health indicators, and optimum pose for each of the selected locations in step 348 of FIG. 7A are shown. At 410, return data, metrics and/or scores based thereon are collected and stored for the selected locations. At 414, the data is used to identify an optimum pose (corresponding to the position and orientation of the vehicle at the selected location) for health assessment. At 418, one visit to each of the selected locations is selected as the reference data for each of the selected locations. The reference data is used as a baseline for comparison with subsequent visits. The differences in the metrics over time are used to assess health and health degradation.

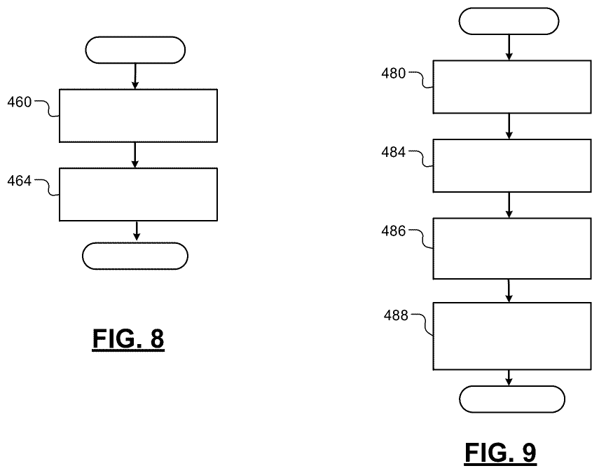

In FIG. 8, steps for eliminating variations across multiple visits in step 218 of FIG. 2 is shown. At 460, enabling criteria is applied to subsequent visits to increase the fidelity of the health assessment. Examples of enabling criteria include environmentally-based criteria such as GPS location (is the vehicle located in a suitable location and/or orientation) and/or reference object detection. Other examples of enabling criteria include temperature, time of day, lighting level, reflectivity level, etc. At 464, the data is adjusted for variations across multiple visits to the same location. In some examples, a transform is applied to the return data to adjust for different vehicle poses or orientations relative to objects at the locations. In some examples, compensation for intensity measurements is performed.

In FIG. 9, steps for monitoring health and health degradation of the LiDAR sensor in step 222 of FIG. 2 are shown. At 480, one or more health indicators are calculated and stored after the vehicle visits one of the selected locations. Examples of health indicators include angular resolution, field of view (FOV), frame rate, and average intensity. At 484, the calculations are repeated during multiple visits to the same location. The calculations from multiple visits to each of the selected locations are summarized using a function such as average, median, or other mathematical and/or logical functions.

At 486, the health indicators are optionally fused (or combined using one or more mathematical or logical functions) and stored across all of the selected locations. The matured health indicators are fused (or combined using one or more mathematical or logical functions) across all selected locations.

At 488, the state of health of the LiDAR sensor 124 is determined. The fused health indicators are monitored over time. In some examples, one or more fixed or adaptive thresholds are applied to the fused health indicators to evaluate the state of health of the LiDAR sensor 124. For example, the state of health can be a declared sufficient when the fused health indicators are greater than (or less than) one of more corresponding predetermined thresholds. For example, the state of health can be declared insufficient when the fused health indicators are less than (or greater than) one of more corresponding predetermined thresholds.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A health monitoring system for a light detection and ranging (LiDAR) sensor of a vehicle, comprising:
a LiDAR sensor configured to generate light pulses and to receive returns;
a location identifying module configured to:
identify locations that are visited by the vehicle;
identify selected ones of the locations as frequently visited locations;
generate metrics for the frequently visited locations based on the returns from the LiDAR sensor; and
based on the metrics, pick selected ones of the frequently visited locations as selected locations for monitoring health of the LiDAR sensor; and
a health monitoring module configured to generate health metrics for the LiDAR sensor when the vehicle is located at the selected locations.

2. The health monitoring system of claim 1, wherein one or more of the metrics are selected from a group consisting of signal to noise ratio, number of return points, and variation in reflectivity.

3. The health monitoring system of claim 1, wherein the location identifying module is configured to pick the selected ones of the frequently visited locations as selected locations by:
assigning useability scores to the frequently visited locations based on the metrics;
ranking the frequently visited locations based on the useability scores; and
picking the selected locations based on the ranking.

4. The health monitoring system of claim 1, wherein the health monitoring module is configured to select one visit to each of the selected locations as corresponding reference data.

5. The health monitoring system of claim 1, wherein the health monitoring module is configured to apply enabling criteria for each of the visits to the selected locations.

6. The health monitoring system of claim 5, wherein the enabling criteria is selected from a group consisting of vehicle location, temperature, light level, time of day, reference object location, and combinations thereof.

7. The health monitoring system of claim 1, wherein the health monitoring module is configured to combine metrics from complementary ones of the selected locations.

8. The health monitoring system of claim 1, wherein the health monitoring module is configured to apply a function to the health metrics for each of the selected locations to generate matured health metrics.

9. The health monitoring system of claim 8, wherein the health monitoring module is configured to fuse one or more of the matured health metrics for two or more of the selected locations to generate a fused metric.

10. The health monitoring system of claim 9, wherein the health monitoring module is configured to compare the fused metric to a predetermined threshold to evaluate the health of the LiDAR sensor.

11. A method for evaluating health of a light detection and ranging (LiDAR) sensor, comprising:
generating light pulses and receiving returns using a LiDAR sensor of a vehicle;
identifying locations that are visited by the vehicle;
identifying selected ones of the locations as frequently visited locations;
generating metrics for the frequently visited locations based on the returns from the LiDAR sensor;
based on the metrics, picking selected ones of the frequently visited locations as selected locations for monitoring health of the LiDAR sensor; and
generating health metrics for the LiDAR sensor when the vehicle is located at the selected locations.

12. The method of claim 11, further comprising selecting the metrics from a group consisting of signal to noise ratio, number of return points, and variation in reflectivity.

13. The method of claim 11, wherein picking the selected ones of the frequently visited locations as selected locations includes:
assigning useability scores to the frequently visited locations based on the metrics;
ranking the frequently visited locations based on the useability scores; and
picking the selected locations based on the ranking.

14. The method of claim 11, further comprising selecting one visit to each of the selected locations as reference data.

15. The method of claim 11, further comprising applying enabling criteria for each of the visits to the selected locations.

16. The method of claim 15, further comprising selecting the enabling criteria from a group consisting of vehicle location, temperature, light level, time of day, reference object location, and combinations thereof.

17. The method of claim 11, further comprising combining metrics from complementary ones of the selected locations.

18. The method of claim 11, further comprising applying a function to the health metrics for each of the selected locations to generate matured health metrics.

19. The method of claim 18, further comprising:
fusing metrics for two or more of the selected locations to generate a fused metric; and
comparing the fused metric to a predetermined threshold to evaluate the health of the LiDAR sensor.

20. A vehicle including:
a light detection and ranging (LiDAR) sensor configured to generate light pulses and to receive returns;
a global positioning system (GPS);
a health assessment module in communication with the LiDAR sensor and the GPS and including:
a location identifying module configured to identify locations that are visited by the vehicle, identify selected ones of the locations as frequently visited locations, generate metrics for the frequently visited locations based on the returns from the LiDAR sensor, and based on the metrics, pick selected ones of the frequently visited locations as selected locations for monitoring health of the LiDAR sensor; and
a health monitoring module configured to generate health metrics for the LiDAR sensor when the vehicle is located at the selected locations,
wherein one or more of the metrics are selected from a group consisting of signal to noise ratio, number of return points, and variation in reflectivity.
